(19) United States
(12) Patent Application Publication
(10) Pub. No.: US 2015/0220236 A1
(43) Pub. Date: Aug. 6, 2015

(54) POST-DESIGNING METHOD AND APPARATUS BASED ON VARIANT CONFIGURATION IN DEVELOPMENT OF GRAPHIC USER INTERFACE

(71) Applicant: Electronics and Telecommunications Research Institute, Daejeon (KR)

(72) Inventor: Jihyun LEE, Daejeon (KR)

(73) Assignee: Electronics and Telecommunications Research Institute, Daejeon (KR)

(21) Appl. No.: 14/535,358

(22) Filed: Nov. 7, 2014

(30) Foreign Application Priority Data
Feb. 6, 2014 (KR) 10-2014-0013466

(51) Int. Cl. G06F 3/0484

(52) U.S. Cl. CPC G06F 3/0484

(57) ABSTRACT

Provided is a tool for developing a Graphic User Interface (GUI). The post-designing method based on variant configuration in development of a GUI, includes generating a Variant Design Model defining a function to be generated through a GUI, generating a Variant-GUI Mapping Model by mapping the Variant Design Model and GUI components in units of screens, defining correlation among a function forming the Variant-GUI Mapping Model, the GUI components, and a domain object required for performing the function, and defining GUI variant information in the Variant-GUI Mapping Model, configuring attribute information of the domain object, and defining a GUI code generation rule corresponding to a GUI execution platform environment, and converting the Variant-GUI Mapping Model into a code executable in the GUI execution platform environment by using the GUI code generation rule, information of the GUI components, and the attribute information of the domain object.

### CROSS-REFERENCE TO RELATED APPLICATIONS

This application claims priority under 35 U.S.C. §119 to Korean Patent Application No. 10-2014-0013466, filed on Feb. 6, 2014, the disclosure of which is incorporated herein by reference in its entirety.

### TECHNICAL FIELD

The present invention relates to a tool for developing a Graphic User Interface (GUI), and more particularly, to a GUI developing method and apparatus for re-selecting and re-configuring a design-alterable portion after a GUI is developed.

### BACKGROUND

With the development of cost-effective, high resolution displays, GUIs have recently been enhanced, and applications thereof have been widely used based on information technologies and information processing regions in almost every field of information technologies, in particular, electrical communications, entertainment electronics, and industrial product and processing plant fields.

In particular, the functions of applications provided through currently released portable terminal devices and Internet services are provided through installed graphic interface software. Graphic interface software is developed in closely relation to functions provided by applications, and GUIs are frequently modified to facilitate alteration of functions and users' access to functions.

In the development of related GUIs by repeating prototype development after design and user testing after development, an operation connected to development of a prototype is not easy after completing software design. For this reason, after the development of a prototype through programming, user testing is repeated in countless numbers.

### SUMMARY

Accordingly, the present invention provides a GUI developing method and apparatus for re-selecting and re-configuring a design-alterable portion after a prototype of GUI is developed.

The object of the present invention is not limited to the aforesaid, but other objects not described herein will be clearly understood by those skilled in the art from descriptions below.

In one general aspect, a post-designing method based on variant configuration in development of a GUI, available to be implemented with a computer includes: generating a Variant Design Model defining a function to be generated through a GUI; generating a Variant-GUI Mapping Model by mapping the Variant Design Model and GUI components in units of screens; defining correlation among a function forming the Variant-GUI Mapping Model, the GUI components, and a domain object required for performing the function, and defining GUI variant information in the Variant-GUI Mapping Model; configuring attribute information of the domain object; and defining a GUI code generation rule corresponding to the environment of GUI execution platform, and converting the Variant-GUI Mapping Model into a code executable in the GUI execution platform environment by using the GUI code generation rule, information of the GUI components, and the attribute information of the domain object.

In another aspect, a post-designing apparatus based on variant configuration in development of a GUI including at least one processor and a nonvolatile memory storing a source code executed by the processor, wherein the source code includes: a Variant Design Modeler configured to generate a Variant Design Model defining a function to be generated through a GUI, and generate a Variant-GUI Mapping Model by mapping the Variant Design Model and GUI components in units of screens; a Reuse Software Asset Definer configured to define correlation among a function of forming the Variant-GUI Mapping Model, the GUI components, and a domain object required for performing the function, and configuring attribute information of the domain object; a GUI Variant Configurer configured to define GUI variant information in the Variant-GUI Mapping Model; and a Code Converter configured to define a GUI code generation rule corresponding to a GUI execution platform environment, and convert the Variant-GUI Mapping Model into a code executable in the GUI execution platform environment by using the GUI code generation rule, information of the GUI components, and the attribute information of the domain object.

### BRIEF DESCRIPTION OF THE DRAWINGS

FIG. 1 is a view illustrating a post-designing apparatus based on variant configuration in development of a GUI according to an embodiment of the present invention.

FIG. 2 is a flow chart illustrating a post-designing method based on variant configuration in development of a GUI according to an embodiment of the present invention.

FIGS. 3A through 3E are views illustrating processes of the post-designing method based on variant configuration of the development of a GUI according to an embodiment of the present invention.

FIG. 4 is a view illustrating an example of a computer device in which the post-designing method based on variant configuration of the development of a GUI according to an embodiment of the present invention is executed.

### DETAILED DESCRIPTION OF EMBODIMENTS

The advantages, features and aspects of the present invention will become apparent from the following description of the embodiments with reference to the accompanying drawings, which is configured forth hereinafter. The present invention may, however, be embodied in different forms and should not be construed as limited to the embodiments configured forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, the detailed descriptions related to well-known functions or configurations will be ruled out in order not to unnecessarily obscure subject matters of the present invention.

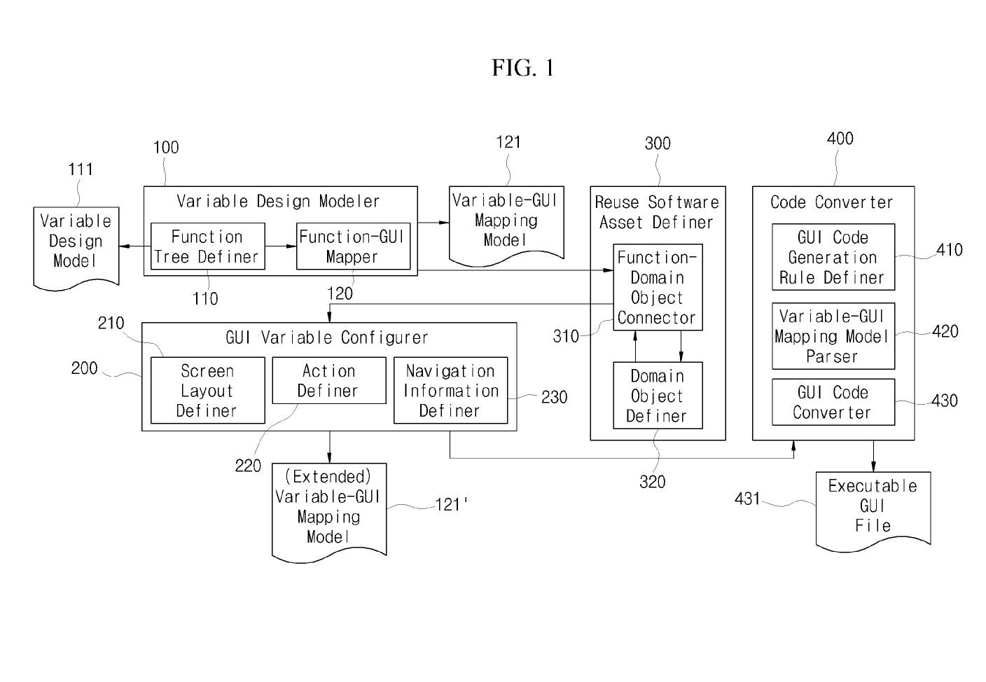

FIG. 1 is a view illustrating a post-designing apparatus based on variant configuration of the development of a GUI according to an embodiment of the present invention.

Referring to FIG. 1, a post-designing apparatus based on variant configuration of the development of a GUI according to an embodiment of the present invention includes a Variant Design Modeler 100, a GUI Variant Configurer 200, a Reuse Software Asset Definer 300, and a Code Converter 400.

The Variant Design Modeler 100 includes a Function Tree Definer 110 and a Function-GUI Mapper 120. The Function Tree Definer 100 supports defining of application functions by a hierarchical structure.

For example, the Function Tree Definer 110 may newly define functions to be executed in an application having a hierarchical structure, or may redefine a function tree to be variably configured by selecting only some functions from a defined tree structure. Here, functions having a hierarchical structure newly defined by the Function Tree Definer 110 or functions having a hierarchical structure partially selected from an existing function tree are defined as a Variant Design Model 111. The Variant Design Model 111 is converted into a Variant-GUI Mapping Model 121 having a structure configured in the form of a graphic user interface that may be accessed by a device user.

A Function-GUI Mapper 120 maps the Variant Design Model 111 and GUI components in units of screens to generate a Variant-GUI Mapping Model 121. Here, components of a GUI configuring a screen are classified to dispose data input, request for a particular function, and results of function execution.

The Variant-GUI Mapping Model 121 refers to a structure of a function selected with a function tree, configured in the form of GUI accessible by a device user. In the Variant-GUI Mapping Model 121, a user interface (UI) structure in which the nodes forming the function tree are to be displayed on a screen of a device, namely, in which type of widget (e.g., a window, a Web page, an execution window, a form, dialog, etc.) the entire GUI screen, is to be expressed is configured.

The Variant Design Model 111 of a sub-hierarchy structure defining functions may not be mapped with the GUI components in units of screens. For example, discrepancies of defined function members, function defining hierarchy level may occur, and when the Variant Design Model 111 cannot be mapped with the GUI components in units of screens, the Function-GUI Mapper 120 may redefine disagreeing functions or GUI components and map the same.

The GUI Variant Configurer 200 includes a Screen Layout Definer 210, an Action Definer 220, and a Navigation Information Definer 230.

The GUI Variant Configurer 200 defines layout, action, and navigation information alterable in a GUI, and partially alters a portion. For example the GUI Variant Configurer 200 additionally configured GUI variant information (e.g., a screen layout, an operation function in a screen to be processed as an action, movement information between screens, which means navigation information) in a function and domain object of the Variant-GUI Mapping Model 121, and converts the Variant-GUI Mapping Model 121 into an extended Variant-GUI Mapping Model 121′. Here, the conversion into the extended Variant-GUI Mapping Model 121′ is performed in a state in which the Variant Design Model 111 is associated with GUI information and domain object.

The Screen Layout Definer 210 defines a layout of GUI components to be disposed in a screen. For example, GUI components such as a label, a text field, a form, and the like, may be disposed in each page. The Screen Layout Definer 210 determines a layout for disposing the GUI components to be positioned in pages by the page, and designates extended features such as a variant type of an alterable component and a GUI type of a GUI component.

The Action Definer 220 defines a function to be processed through the GUI components, and selects an association between a function to be executed and a GUI component from among a button and a menu. The Action Definer 220 defines preconditions, performing codes, and post-conditions of a function to be executed, and designates a variant type of an alterable component. In this case, a GUI component that calls an action and screen movement information to be moved after calling the action are mapped together.

The Navigation Information Definer 230 defines navigation information in a button, link, and menu scheme according to the purpose in the screen movement, and designates a variant type of an alterable component. In detail, a Web page movement may be divided into a submit scheme, a link scheme, and a menu scheme according to movement purposes. For example, in a form UI, the submit scheme needs to be configured to move to a different resultant page by pressing a button. The scheme of linking to a particular position of the same (or different) page refers to a scheme of moving by using “<a” link. The menu scheme refers to a scheme of moving a page by selecting a menu name in a menu bar.

The Reuse Software Asset Definer 300 includes a Function-Domain Object Connector 310 and a Domain Object Definer 320. The Reuse Software Asset Definer 300 serves to define a domain object and connect a GUI component and a domain object.

Here, the domain object refers to a user definition data type having a field and a function as sub-properties. The function is a function for a domain object and for processing an object. Thus, the domain object relates to a function defined by the Function Tree Definer 110. In an embodiment of the present invention, the relation between a function-GUI screen-domain object and a domain object aggregation is defined through mapping, and the alteration of the relation between them is facilitated.

The Function-Domain Object Connector 310 searches for a domain object required for performing selected functions defined by the Variant Design Model 111 and maps the same domain object.

The Domain Object Definer 320 configures a value to a variant of attributes of domain objects mapped to a function. The value configured to a variant of the attributes of the domain objects is a portion, namely, a variation point, which may be alterable when a design determining matter occurs.

The Code Converter 400 includes a GUI Code Generation Rule Definer 410, a Variant-GUI Mapping Model Parser 420, and a GUI Code Converter 430. The Code Converter 400 converts a Variant-GUI Mapping Model into an execution file available for displaying a GUI screen.

The GUI Code Generation Rule Definer 410 supports creation of a rule for converting the Variant-GUI Mapping Model 121 desired to be converted, into a code of a programming language in a GUI execution platform environment. The rule defines a partial code to reflect an element forming the Variant-GUI Mapping Model 121. Also, a code template where a converted partial code is to be positioned and position information in a template is also defined by the GUI code generation rule. The code template and the converted partial code are combined to configure an executable GUI file. For example, the GUI Code Generation Rule Definer 410 may generate the rule defining a relationship regarding an attribute type of a domain object and a type of a GUI component mapped to a domain object.

The Variant-GUI Mapping Model Parser 420 parses the extended Variant-GUI Mapping Model 121′ to configure model components (model component name, mapped variant value, and etc.) forming the extended Variant-GUI Mapping Model 121′ as a pair.

The GUI Code Converter 430 generates a GUI partial conversion code by using the analysis result (model component name and mapped variant value) of the Variant GUI Mapping Model Parser 420 and a GUI code generation rule, and combines the generated GUI partial conversion code with a code template to configure an Executable GUI File.

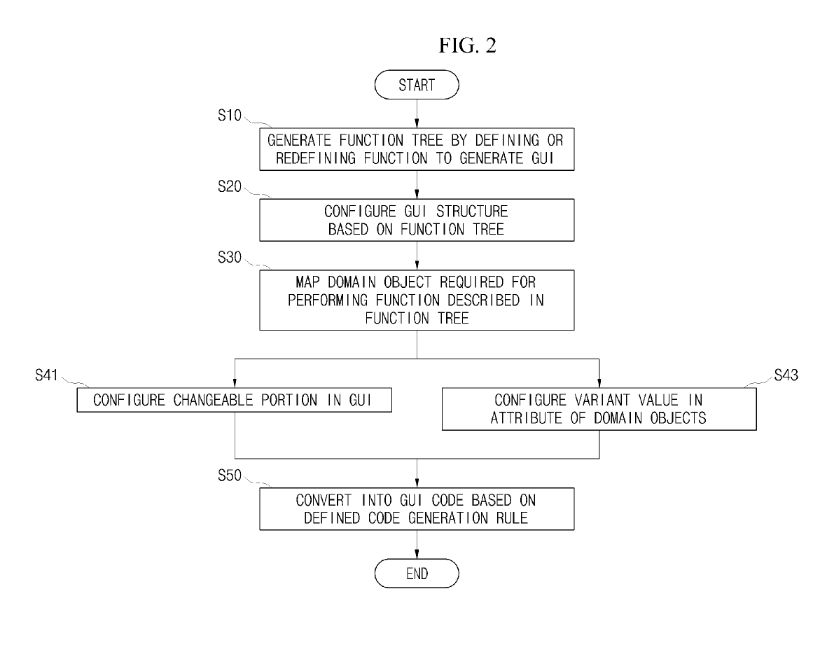

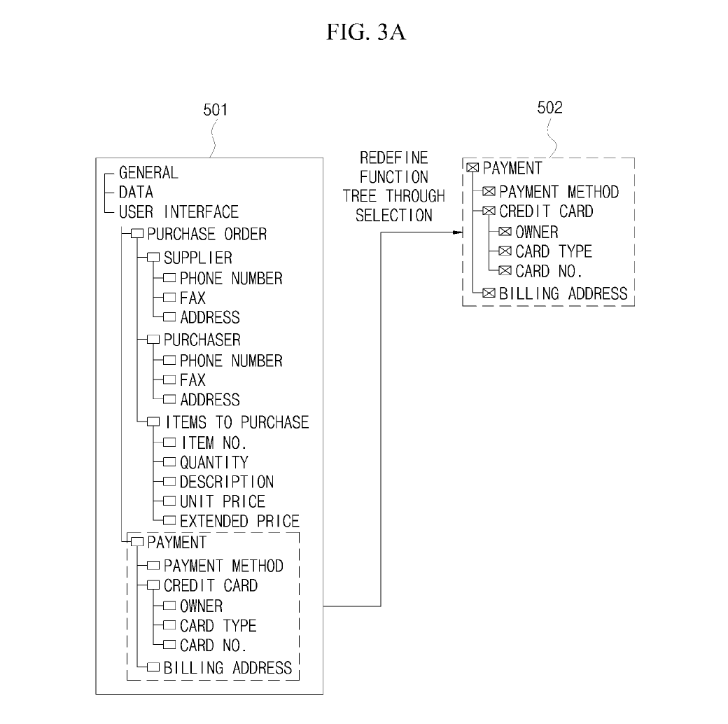

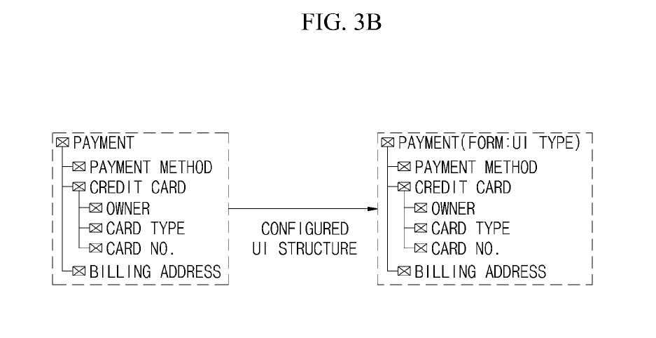

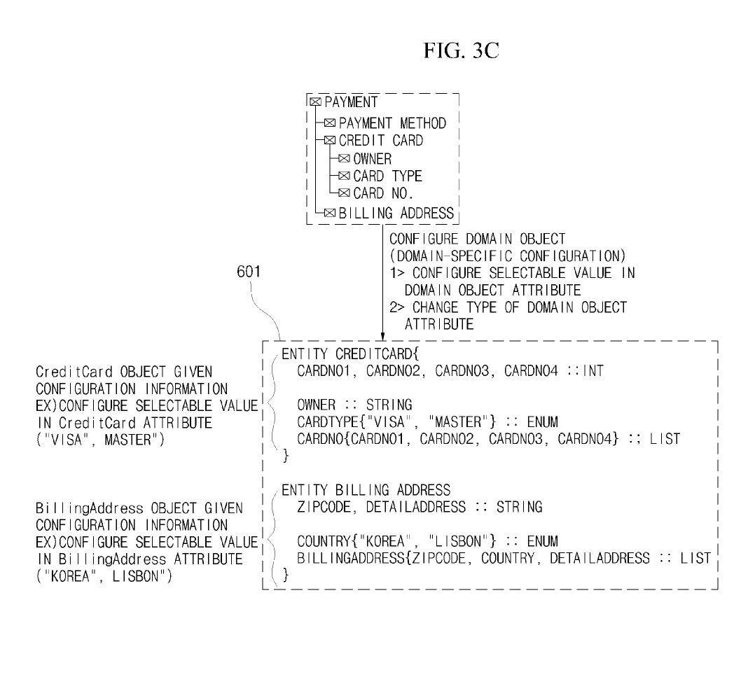

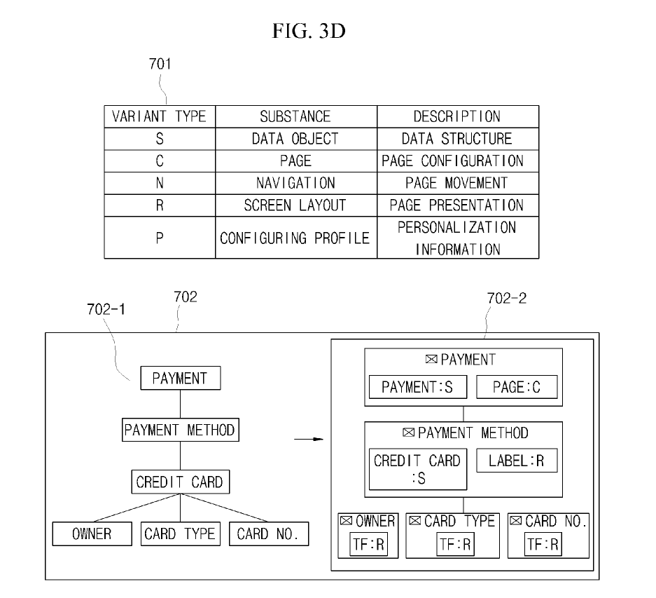

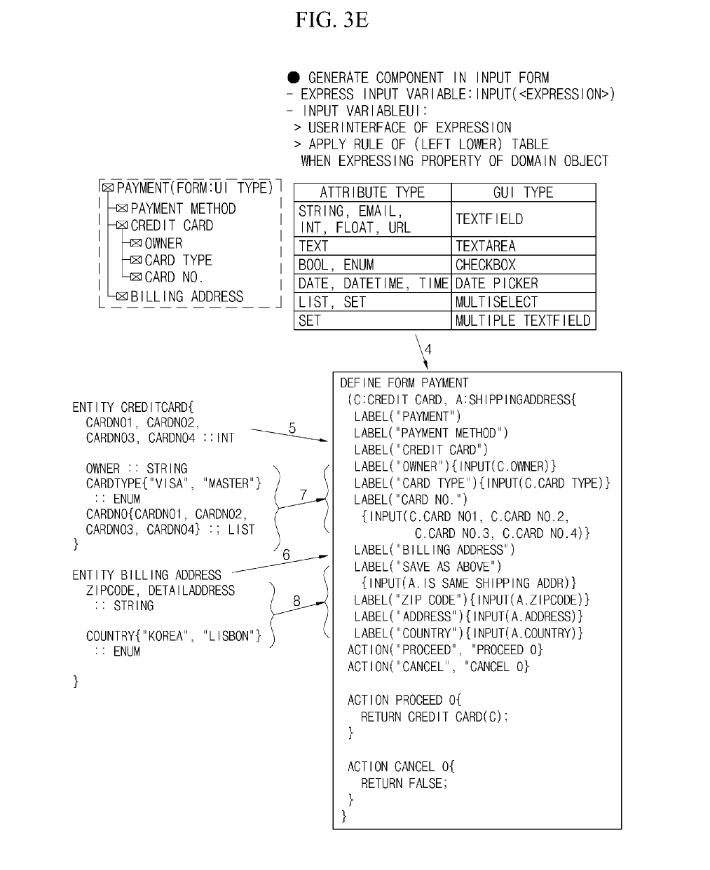

FIG. 2 is a flow chart illustrating a post-designing method based on variant configuration in development of a GUI according to an embodiment of the present invention. Hereinafter, the post-designing method based on variant configuration in development of a GUI according to an embodiment of the present invention will be described with reference to FIGS. 2 and 3. FIGS. 3A through 3E are views illustrating processes of the post-designing method based on variant configuration of the development of a GUI according to an embodiment of the present invention.

In step S10, the Function Tree Definer 110 defines and redefines a function for generating a GUI to generate a function tree. A function to be performed in an application having a hierarchical structure form is generated through the Function Tree Definer 110, and the defining result is illustrated as two types in FIG. 2. For example, a function tree may be newly defined or a portion of a defined function tree may be selected. An example of newly defining is illustrated in the left 501 of FIG. 3A, and an example of a function tree of a hierarchical structure partially selected from an existing function tree is illustrated in the right 502 of FIG. 3A. Here, functions of the hierarchical structure newly defined by the Function Tree Definer 110 or functions of the hierarchical structure partially selected from an existing function tree are defined as the Variant Design Model 111.

In step S20, the Function-GUI Mapper 120 maps the Variant Design Model 111 and GUI components in units of screens to generate a Variant-GUI Mapping Model 121. Here, the Variant-GUI Mapping Model 121 refers to a structure configured in a GUI form allowing a device user to access a function selected by the function tree.

The Function-GUI Mapper 120 configures a function selected by the function tree to a structure in a GUI form accessible by a device user, namely, a UI structure for each node forming the function tree to be displayed on a screen of the device. For example, the Function-GUI Mapper 120 configures in which type of widget (e.g., a window, a Web page, an execution window, a form, dialog, etc.) the entire GUI screen mapped to a function is to be expressed. Like the function tree, the GUI screen has a hierarchical form in a tree form, and includes parent-children relation including GUI components required for each low level in a topmost mapping GUI or includes a relation or brothers and sisters structured at the same level. FIG. 3B illustrates that a function tree is mapped as a GUI type in a topmost form.

In step S30, the Function-Domain Object Connector 310 searches and maps domain objects required for performing the selected functions defined by the Variant Design Model 111.

In step S41, the GUI Variant Configurer 200 configures variant attributes related to a screen layout, action, and navigation alterable in a GUI. The configuring of variant attributes related to GUI layout, action, and navigation includes, for example, mapping GUI layout components to attributes of each function of the function tree through extension of the function tree, and designating variant types of the mapped GUI layout components. Reference numeral 701 in FIG. 3D denotes variant types. The variant types are classified as S (data object), C (screen configuration unit, e.g., page), N (page movement information, i.e., navigation), R (screen layout information), and P (personal GUI configuration information). Reference numeral 702-1 denotes a function tree, and reference numeral 702-2 denotes an extended function tree stating GUI layout components mapped to the function tree and variant types of the components. Here, the extended function tree refers to an extended Variant-GUI Mapping Model 121′ converted in a state in which the Variant Design Model 111 are associated with GUI information and domain objects.

In step S41 and step S43 in parallel or sequentially, the Domain Object Definer 320 configures variant values in attributes of the domain objects mapped to functions. The variant values configured with respect to the attributes of the domain objects are a portion alterable when a design decision matter occurs, namely, variation points.

Configuration of domain objects performs functions of (1) a case of configuring a selectable value in a defined domain object and (2) a case of altering an attribute type of a domain object. The two types of domain object configuration functions may be executed simultaneously or separately. Reference numeral 601 of FIG. 3C shows that a domain object defined by the Domain Object Definer 320 includes an object name, an attribute, and an attribute type. Also, the portion in red color in reference numeral 601 denotes information configured in the domain object. For example, the card type and the country are attributes with respect to domain objects for Credit Card and Billing Address, selectable values (Visa, Master/Korea, Lisbon) are configured in the corresponding attributes, and an attribute type is configured as Enum.

In step S50, the GUI Code Converter 430 defines a GUI code generation rule, generates a GUI partial conversion code by using the GUI code generation rule, the attribute information of the domain objects, and the GUI component information, and combines the generated GUI partial conversion code to configure an Executable GUI File (431).

FIG. 3E illustrates step of defining a GUI code generation rule and step of configuring a GUI execution file. In FIG. 3E, reference numeral 801 defines a relationship between parsed domain object configuration information and convertible GUI type in the GUI code generation rule. This is defined as a definition object-GUI type mapping table. In detail, In FIG. 3, the arrows 4, 5, 6, 7, and 8 denote a detailed step in which the Code Converter 400 perform code conversion based on the domain definition object-GUI type mapping table, the parsed domain object configuration information, and the GUI configuration component information to generate a GUI execution file. The arrows 9 and 10 denote a GUI component and an action that may be input in addition to the code conversion in the Variant-GUI Mapping Model.

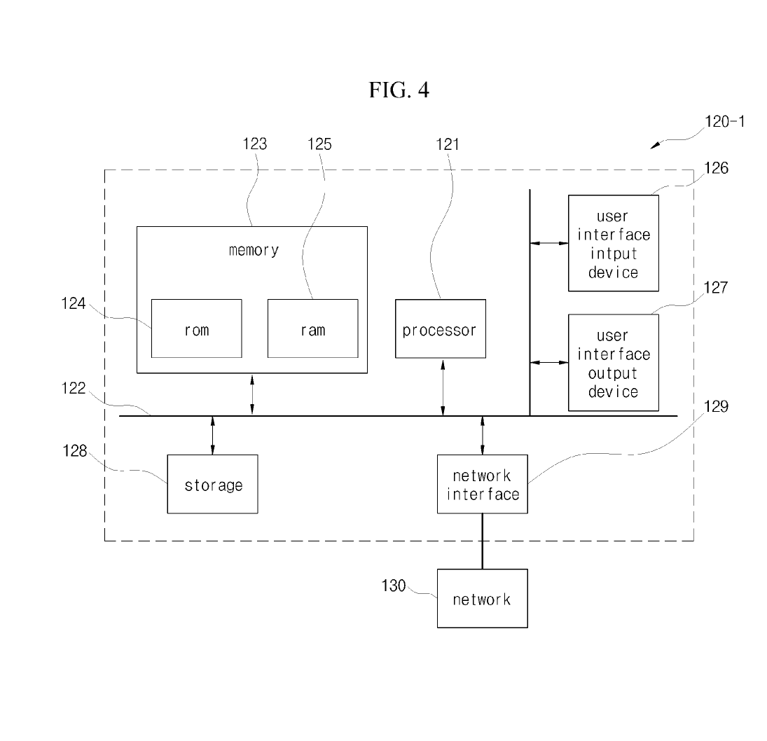

The post-designing method based on a variant configuration in development of a GUI according to an embodiment of the present invention may be implemented in a computer system or recorded in a recording medium. FIG. 4 illustrates a simple embodiment of a computer system. As illustrated, the computer system may include one or more processors 121, a memory 123, a user interface input device 126, a data communication bus 122, a user interface output device 127, a storage 128, and the like. The foregoing components perform data communication through the data communication bus 122.

The computer system may further include a network interface coupled to a network. The processor 121 may be a central processing unit (CPU) or a semiconductor device processing a command stored in the memory 123 and/or the storage 128.

The memory 123 and the storage 128 may include various types of volatile or nonvolatile storage mediums. For example, the memory 123 may include a ROM 124 and a RAM 125.

According to an embodiment of the present invention, function-GUI screen-domain object, and domain object aggregation provided in an application are mapped and defined based on relations, and the relations therebetween can be easily altered. Thus, compared with the existing GUI development method in which a work series of design, prototype development, user testing is repeated based on manually operated coding, flexibility allowing an alterable portion to be reselected and reconfigured in developing a GUI can be provided.

Thus, the post-designing method based on variant configuration in development of a GUI according to an embodiment of the present invention may be implemented as a computer-executable method. When the post-designing method based on variant configuration in development of a GUI according to an embodiment of the present invention is executed in a computer device, computer-readable commands may perform an aligning method according to an embodiment of the present invention.

The post-designing method based on variant configuration in development of a GUI according to the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A post-designing method based on variant configuration in development of a graphic user interface (GUI), available to be implemented with a computer, the post-designing method comprising:
generating a Variant Design Model defining a function to be generated through a GUI; generating a Variant-GUI Mapping Model by mapping the Variant Design Model and GUI components in units of screens;
defining correlation among a function forming the Variant-GUI Mapping Model, the GUI components, and a domain object required for performing the function, and defining GUI variant information in the Variant-GUI Mapping Model;
configuring attribute information of the domain object; and
defining a GUI code generation rule corresponding to a GUI execution platform environment, and converting the Variant-GUI Mapping Model into a code executable in the GUI execution platform environment by using the GUI code generation rule, information of the GUI components, and the attribute information of the domain object.

2. The post-designing method of claim 1, wherein the generating of a Variant Design Model comprises defining a function to be performed in an application having a hierarchical structure by a tree structure.

3. The post-designing method of claim 1, wherein the generating of a Variant Design Model comprises selecting a partial function from the function tree defining a function to be performed in the application having the hierarchical structure.

4. The post-designing method of claim 1, wherein the generating of a Variant-GUI Mapping Model comprises configuring each function forming the Variant Design Model in the form of a widget to be expressed on a screen of a device.

5. The post-designing method of claim 1, wherein the defining of GUI variant information in the Variant-GUI Mapping Model comprises configuring variant attributes related to a screen layout, action, and navigation alterable in the GUI components.

6. The post-designing method of claim 1, wherein the defining of GUI variant information in the Variant-GUI Mapping Model comprises:
mapping a GUI layout component to an attribute of a function forming the Variant-GUI Mapping Model; and
designating a type of a variant corresponding to the GUI layout component.

7. The post-designing method of claim 6, wherein the variant type comprises a data object, a screen configuration unit, page movement information, screen layout information, and personal GUI configuration information of the GUI layout component.

8. The post-designing method of claim 1, wherein the configuring of attribute information of a domain object comprises configuring a value to a variant of attributes of domain objects mapped to functions forming the Variant-GUI Mapping Model.

9. The post-designing method of claim 1, wherein the configuring of attribute information of a domain object comprises configuring a selectable value in a domain object having defined correlation or altering the attribute type of a domain object.

10. The post-designing method of claim 1, wherein the converting into a code executable in the GUI execution platform environment comprises generating a GUI code generation rule defining a relationship regarding the attribute type of a domain object and a type of GUI component mapped to the domain object.

11. A post-designing apparatus based on variant configuration in development of a GUI including at least one processor and a nonvolatile memory storing a source code executed by the processor, wherein the source code comprises:
a Variant Design Modeler configured to generate a Variant Design Model defining a function to be generated through a GUI, and generate a Variant-GUI Mapping Model by mapping the Variant Design Model and GUI components in units of screens;
a Reuse Software Asset Definer configured to define correlation among a function of forming the Variant-GUI Mapping Model, the GUI components, and a domain object required for performing the function, and configuring attribute information of the domain object;
a GUI Variant Configurer configured to define GUI variant information in the Variant-GUI Mapping Model; and
a Code Converter configured to define a GUI code generation rule corresponding to a GUI execution platform environment, and convert the Variant-GUI Mapping Model into a code executable in the GUI execution platform environment by using the GUI code generation rule, information of the GUI components, and the attribute information of the domain object.

12. The post-designing apparatus of claim 11, wherein the Variant Design Modeler defines a function to be performed in an application having a hierarchical structure by a tree structure to generate the Variant-GUI Mapping Model.

13. The post-designing apparatus of claim 11, wherein the Variant Design Modeler selects a partial function from the function tree defining a function to be performed in the application having the hierarchical structure to generate the Variant-GUI Mapping Model.

14. The post-designing apparatus of claim 11, wherein the Variant Design Modeler configures each function forming the Variant Design Model in the form of a widget to be expressed on a screen of a device.

15. The post-designing apparatus of claim 11, wherein the Reuse Software Asset Definer configures a value to a variant in attributes of domain objects mapped to functions forming the Variant-GUI Mapping Model.

16. The post-designing apparatus of claim 15, wherein the Reuse Software Asset Definer configures a selectable value in a domain object having defined correlation or alters attribute types of the domain objects to configure a value to a variant of the attributes of the domain objects.

17. The post-designing apparatus of claim 11, wherein the GUI Variant Configurer configures variant attributes related to a screen layout, action, and navigation alterable in the GUI components, maps a GUI layout component to an attribute of a function forming the Variant-GUI Mapping Model, and designates a variant type of the GUI layout component.

18. The post-designing apparatus of claim 17, wherein the variant type comprises a data object, a screen configuration unit, page movement information, screen layout information, and personal GUI configuration information of the GUI layout component.

19. The post-designing apparatus of claim 11, wherein the Code Converter generates a GUI code generation rule defining a relationship regarding the attribute type of a domain object and a type of GUI component mapped to the domain object.
